(19) United States
(12) Patent Application Publication
(10) Pub. No.: US 2017/0139308 A1
(43) Pub. Date: May 18, 2017

(54) FILTER CONTROL DEVICE, FILTER CONTROLLING METHOD, AND IMAGING DEVICE

(71) Applicant: SONY CORPORATION, TOKYO (JP)

(72) Inventors: JUN MINAKUTI, TOKYO (JP); AKIRA TAKEO, SAITAMA (JP); YASUTOSHI KATSUDA, TOKYO (JP)

(21) Appl. No.: 15/320,465

(22) PCT Filed: Jun. 10, 2015
(86) PCT No.: PCT/JP2015/066698

§ 371 Date: Dec. 20, 2016

(30) Foreign Application Priority Data
Jul. 3, 2014 (JP) 2014-138060

(51) Int. Cl. G03B 11/00; H04N 5/232; H04N 5/262; H04N 5/225

(52) U.S. Cl. CPC G03B 11/00; H04N 5/2254; H04N 5/23229; H04N 5/2628; H04N 5/23212; H04N 5/23293

(57) ABSTRACT

A filter control device of the present disclosure includes a filter controller that performs control on a shot image to cause low-pass characteristics of an optical low-pass filter mounted in an imaging device to be changed in accordance with a magnification of the image, the magnification to be changed by image processing.

### CROSS REFERENCE TO RELATED APPLICATIONS

This application is a U.S. National Phase of International Patent Application No. PCT/JP2015/066698 filed on Jun. 10, 2015, which claims priority benefit of Japanese Patent Application No. JP 2014-138060 filed in the Japan Patent Office on Jul. 3, 2014. Each of the above-referenced applications is hereby incorporated herein by reference in its entirety.

### TECHNICAL FIELD

The present disclosure relates to a filter control device and a filter controlling method that are suitable for an imaging device (camera) shooting a still image or a moving image, and an imaging device.

### BACKGROUND ART

In order to avoid a false signal caused by aliasing that results from sampling during imaging, a digital camera generally includes an optical low-pass filter (OLPF) (refer to Patent Literatures 1 and 2).

### CITATION LIST

### Patent Literature

Patent Literature 1: Japanese Unexamined Patent Application Publication No. 2013-156379

Patent Literature 2: Japanese Unexamined Patent Application Publication No. 2013-190603

### DISCLOSURE OF INVENTION

A typical optical low-pass filter has only one kind of low-pass characteristics that are determined at design time. Accordingly, when the low-pass characteristics are set to be strong in order to reduce false signals, sharpness of an image is degraded. In contrast, when degradation in sharpness is suppressed, false signals are increased. In other words, in a case with one kind of low-pass characteristics, it is difficult to achieve compatibility between these image quality factors that are in a trade-off relation.

There is known a technology to perform enlargement or reduction of an image by changing a magnification of the image by image processing. In a case in which an image is enlarged, a process of interpolating a pixel value is performed. At this occasion, degradation in sharpness associated with enlargement and interpolation causes degradation in image quality. Moreover, in a case in which a periodic false signal such as moire is generated during image shooting, the periodic false signal is moved to a low-frequency region by enlargement to be made more noticeable, thereby resulting in degradation in image quality.

Although image processing makes it possible to correct degradation in sharpness to some extent, this processing enhances, for example, noise at the same time, thereby causing degradation in image quality due to other factors. When the optical low-pass filter is not mounted, it is possible to achieve, without increasing noise, an improvement in all aspects of sharpness including sharpness degraded at the time of enlargement. Accordingly, in related art, a camera without the optical low-pass filter is adopted to enhance sharpness. However, such a camera does not prevent generation of the false signal that is in a tradeoff relation with sharpness, and is not therefore a desirable solution. Moreover, there is known a technology in which mechanical switching is performed between insertion and non-insertion of the optical low-pass filter in an optical path. However, in this method, only two states, i.e., a state with a low-pass effect and a state without a low-pass effect are applicable, and it is difficult for the method to sufficiently cope with different degrees of degradation in sharpness by an enlargement magnification. In addition, since recording is continuously performed during moving image shooting, in a case in which an operation of enlarging an image during image shooting (electronic zoom) is performed, switching of the optical low-pass filter is not allowed, and it is difficult for this method to cope with the above issue.

It is therefore desirable to provide a filter control device and a filter controlling method that make it possible to achieve an image with high image quality, and an imaging device.

A filter control device according to an embodiment of the present disclosure includes a filter controller that performs control on a shot image to cause low-pass characteristics of an optical low-pass filter mounted in an imaging device to be changed in accordance with a magnification of the image, the magnification to be changed by image processing.

A filter controlling method according to an embodiment of the present disclosure includes performing control on a shot image to cause low-pass characteristics of an optical low-pass filter mounted in an imaging device to be changed in accordance with a magnification of the image, the magnification to be changed by image processing.

An imaging device according to an embodiment of the present disclosure includes: an optical low-pass filter; and a filter controller that performs control on a shot image to cause low-pass characteristics of the optical low-pass filter to be changed in accordance with a magnification of the image, the magnification to be changed by image processing.

In the filter control device, the filter controlling method, or the imaging device according to the embodiment of the present disclosure, when the magnification of the shot image is changed by image processing, the low-pass characteristics of the optical low-pass filter are changed in accordance with the magnification.

According to the filter control device, the filter controlling method, or the imaging device according to the embodiment of the present disclosure, when the magnification of the shot image is changed by image processing, the low-pass characteristics of the optical low-pass filter are changed in accordance with the magnification, which makes it possible to achieve an image with high image quality.

Note that effects described here are non-limiting, and may be one or more of effects described in the present disclosure.

### BRIEF DESCRIPTION OF DRAWINGS

FIG. 1 is a block diagram illustrating a configuration example of a camera (an imaging device) including a filter control device according to an embodiment of the present disclosure.

FIG. 2 is a block diagram illustrating a configuration example of an external device that processes Raw data.

FIG. 3 is a cross-sectional view of a configuration example of a variable optical low-pass filter.

FIG. 4 is an illustration of an example of a state in which a low-pass effect of the variable optical low-pass filter illustrated in FIG. 3 is 0%.

FIG. 5 is an illustration of an example of a state in which the low-pass effect of the variable optical low-pass filter illustrated in FIG. 3 is 100%.

FIG. 6 is an illustration of an example of a state in which the low-pass effect of the variable optical low-pass filter illustrated in FIG. 3 is 50%.

FIG. 7 is a characteristic diagram illustrating an example of change in MTF characteristics by an applied voltage to the variable optical low-pass filter illustrated in FIG. 3.

FIG. 8 is a characteristic diagram illustrating an example of change in MTF characteristics by an applied voltage in a case in which an imaging lens is combined with the variable optical low-pass filter illustrated in FIG. 3.

FIG. 9 is a characteristic diagram illustrating an example of MTF characteristics of a typical optical low-pass filter.

FIG. 10 is an illustration of an example of change in MTF characteristics at the time of image enlargement.

FIG. 11 is an illustration of an example of change in MTF characteristics by different pixel interpolation algorithms at the time of image enlargement.

FIG. 12 is an illustration of an example in which degradation in MTF characteristics at the time of image enlargement are corrected by changing low-pass characteristics.

FIG. 13 is an illustration of an example in which degradation in MTF characteristics at the time of image enhancement are corrected with combined use of change in low-pass characteristics and sharpness correction.

FIG. 14 is an illustration of an example in a case in which the low-pass effect and sharpness correction are enhanced, as compared with correction in FIG. 13.

FIG. 15 is an illustration of an example of aliasing caused at the time of image reduction.

FIG. 16 is an illustration of an example in which the aliasing illustrated in FIG. 15 is suppressed by the low-pass effect of the variable optical low-pass filter.

FIG. 17 is a flowchart illustrating an example of a flow of entire control of the camera.

FIG. 18 is a flowchart illustrating an example of a flow of control in a live view process (1).

FIG. 19 is a flowchart illustrating an example of a flow of control in a still image shooting process.

FIG. 20 is a flowchart illustrating an example of a flow of control in a moving image shooting process.

FIG. 21 is an illustration of an example of an applied voltage to the variable optical low-pass filter that is used when a low-pass effect adjustment mode is a normal mode.

FIG. 22 is an illustration of an example of a high-pass filter for detection of a high-frequency component that is used when the low-pass effect adjustment mode is in an automatic mode.

FIG. 23 is an illustration of an example of a sharpness correction amount (a spatial filter coefficient) in accordance with the applied voltage to the variable optical low-pass filter.

FIG. 24 is a cross-sectional view of another configuration example of the variable optical low-pass filter.

### MODES FOR CARRYING OUT THE INVENTION

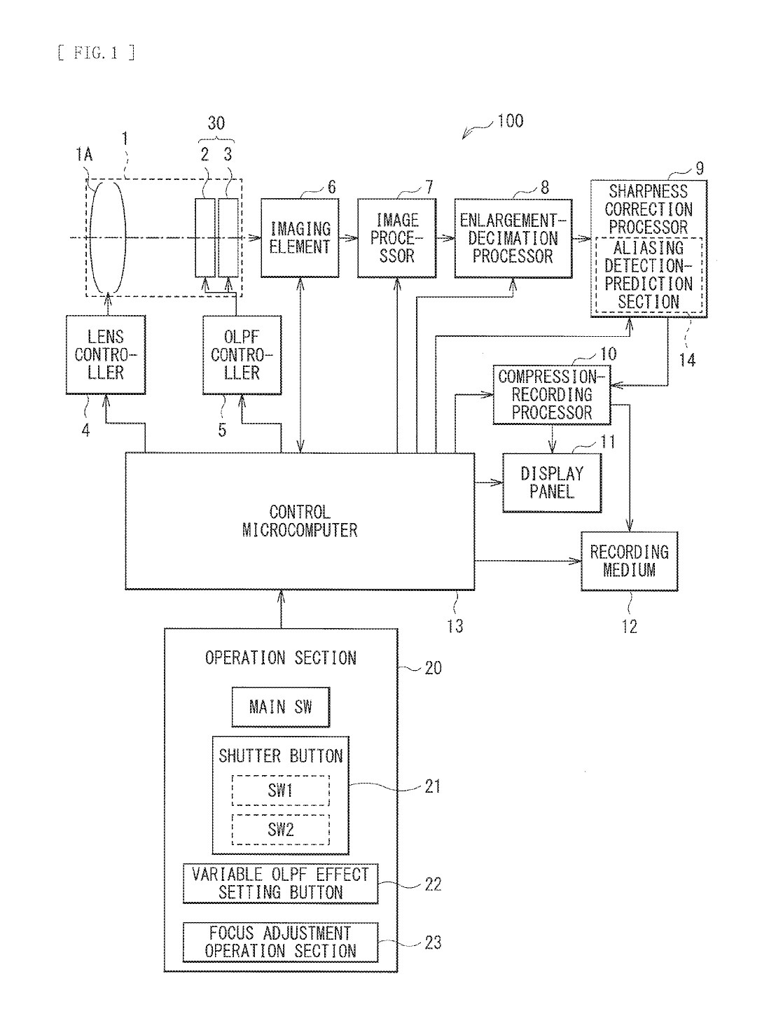

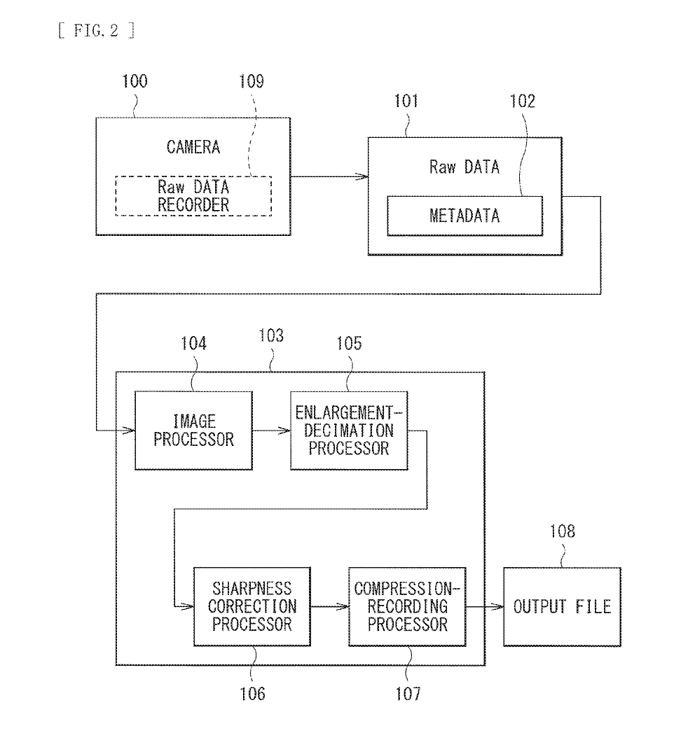

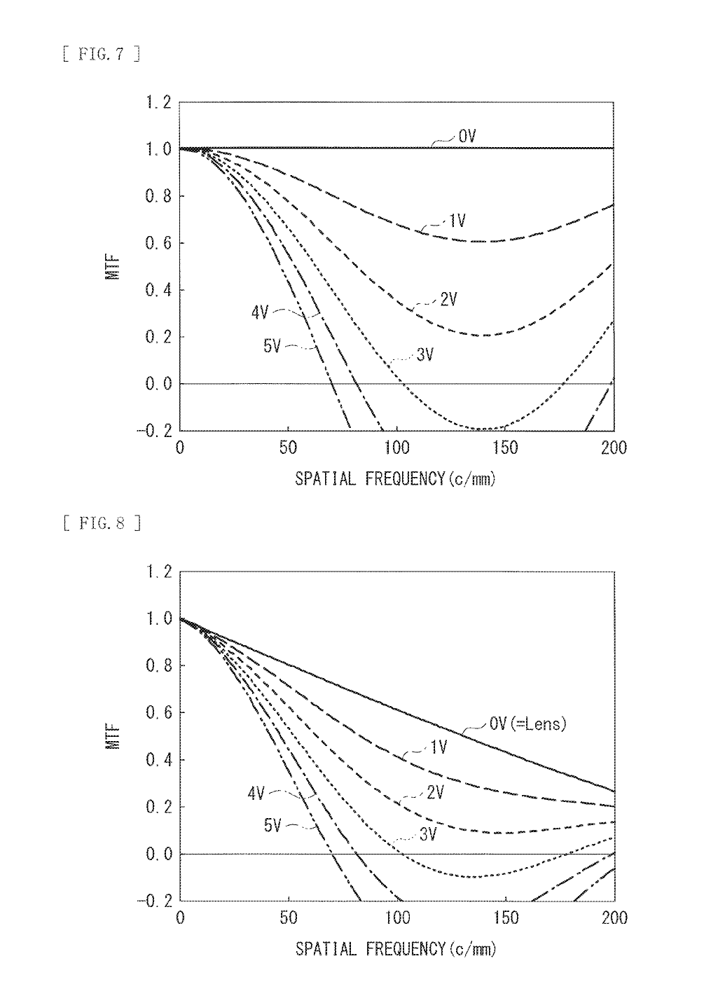

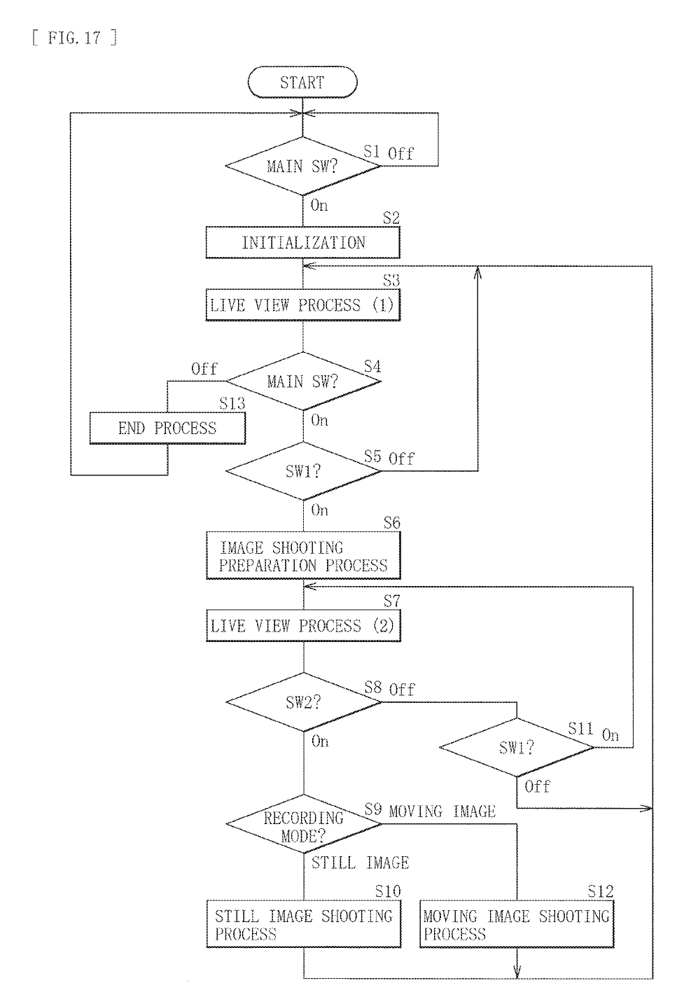

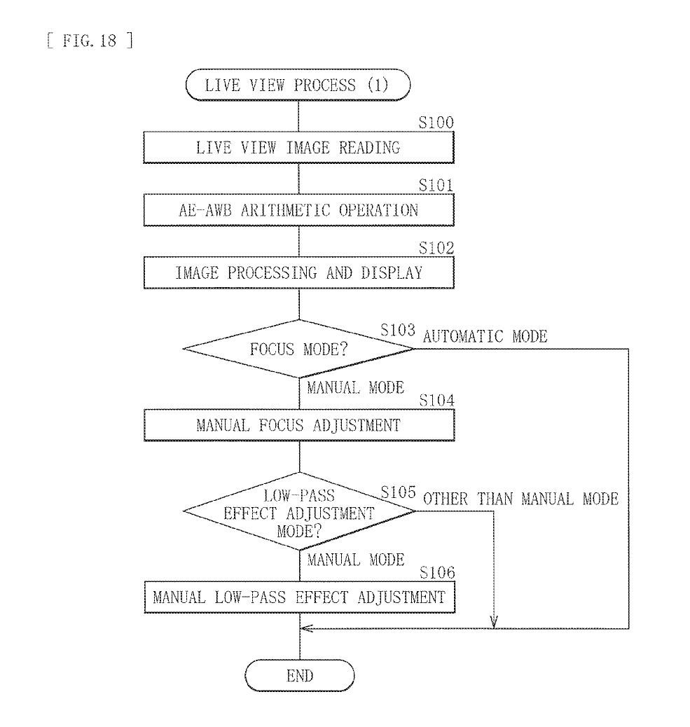

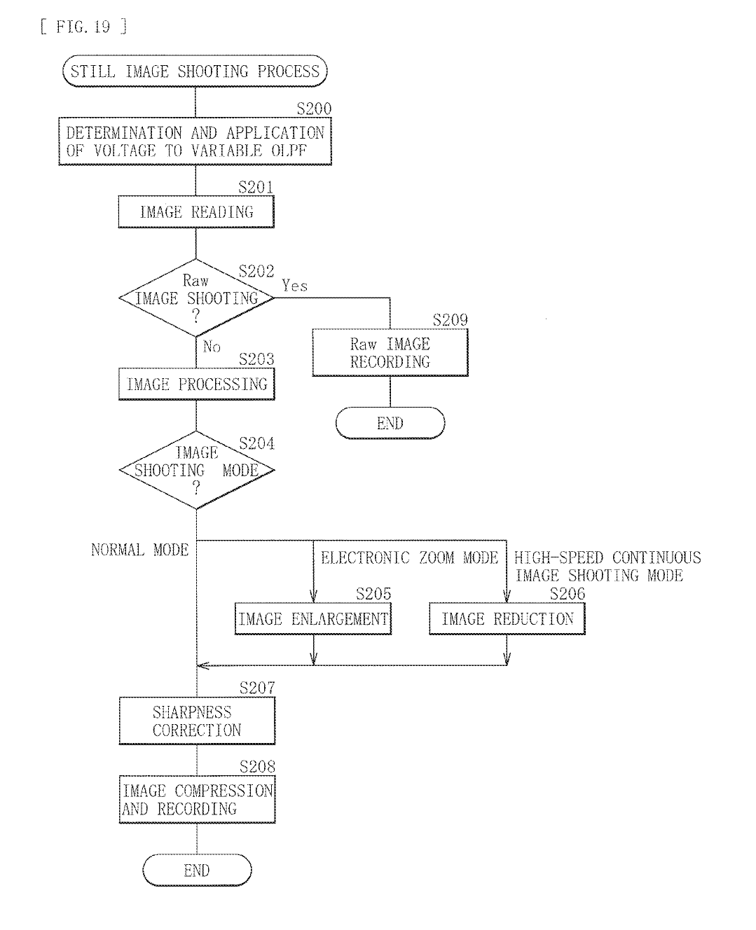

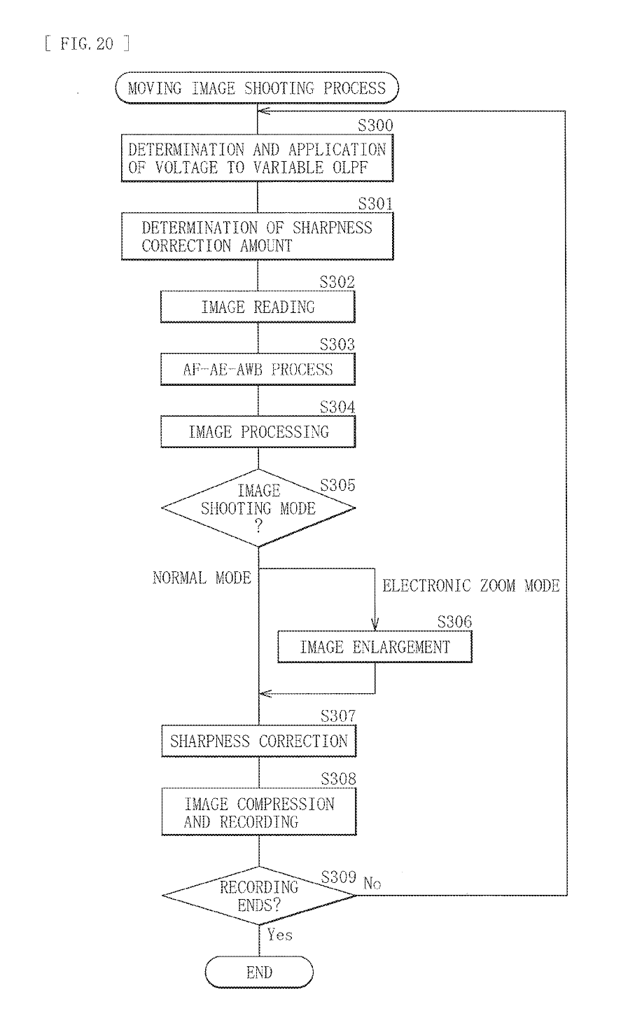

In the following, some embodiments of the present disclosure are described in detail with reference to the drawings. It is to be noted that description is given in the following order.
<1. Configuration>
[1.1 Configuration Example of Camera (Imaging Device)] (FIG. 1)
[1.2 Configuration Example of External Device Processing Raw Data] (FIG. 2)
[1.3 Configuration and Principle of Variable Optical Low-pass Filter] (FIGS. 3 to 6)
[1.4 Degradation in Image Quality in Image Processing and Solution thereto] (FIGS. 7 to 16)
<2. Operation>
[2.1 Entire Control Operation of Camera] (FIG. 17)
[2.2 Live View Process] (FIG. 18)
[2.3 Still Image shooting Process] (FIG. 19 and FIGS. 21 to 23)
[2.4 Moving Image shooting Process] (FIG. 20)
<3. Effects>
<4. Other Embodiments>

### 1. Configuration

### [1.1 Configuration Example of Camera (Imaging Device)]

FIG. 1 illustrates a configuration example of a camera (an imaging device) 100 including a filter control device according to an embodiment of the present disclosure. The camera 100 includes an imaging optical system 1, a lens controller 4, a variable optical low-pass filter controller (OLPF controller) 5, an imaging element 6, and an image processor 7. The camera 100 further includes an enlargement-decimation processor 8, a sharpness correction processor 9, a compression-recording processor 10, a display panel 11, a recording medium 12, a control microcomputer 13, and an operation section 20.

The imaging optical system 1 includes an imaging lens 1A and a variable optical low-pass filter (a variable OLPF) 30. The imaging lens 1A is adapted to form an optical subject image on the imaging element 6. The imaging lens 1A includes a plurality of lenses, and enables optical focus adjustment and zoom adjustment by moving one or more of the lenses. The variable optical low-pass filter 30 may be built in the image optical system 1, or may be mounted by a user as an exchangeable filter. The lens controller 4 is adapted to drive one or more of the lenses in the imaging lens 1A for optical zoom magnification, focus adjustment, and other adjustment. The imaging element 6 is adapted to convert the subject image formed on a light reception surface through the imaging lens 1A and the variable optical low-pass filter 30 into an electrical signal by photoelectric conversion to generate image data. The imaging element 6 may be configured of, for example, a CCD (Charge Coupled Device) or a CMOS (Complementary Metal Oxide Semiconductor) image sensor.

The image processor 7 is adapted to perform image processing on the image data read from the imaging element 6. Non-limiting examples of the image processing may include white balance, demosaicing, grayscale conversion, color conversion, and noise reduction.

The display panel 11 may be configured of, for example, a liquid crystal panel, and has a function as a display section that displays a live view image. In addition thereto, a device setting menu or a user operation state may be displayed on the display panel 11. Further, various kinds of image shooting data such as image shooting conditions may be displayed.

The compression-recording processor 10 is adapted to perform processing such as conversion of image data into display data suitable for display on the display panel 11 and conversion of image data into data suitable for recording on the recording medium 12. The recording medium 12 is adapted to hold shot image data. In general, the compression-recording processor 10 records compressed image data such as JPEG as image data to be recorded on the recording medium 12. In addition thereto, so-called Raw data may be recorded on the recording medium 12.

The operation section 20 includes a main switch (main SW), a shutter button 21, a variable OLPF effect setting button 22, and a focus adjustment operation section 23. The operation section 20 further includes a switch SW1 and a switch SW2 that are each turned on in response to a pressing amount of the shutter button 21.

The focus adjustment operation section 23 enables manual focus adjustment, and may be, for example, a focus adjustment ring provided to a lens barrel of the imaging lens 1A. The variable OLPF effect setting button 22 is adapted to manually set low-pass characteristics of the variable optical low-pass filter 30.

The variable optical low-pass filter 30 includes a first variable optical low-pass filter 2 and a second variable optical low-pass filter 3. In a case in which the variable optical low-pass filter 30 is of a type that controls low-pass characteristics in a specific one-dimensional direction, using two variable optical low-pass filters 30 (the first variable optical low-pass filter 2 and the second variable optical low-pass filter 3) makes it possible to control low-pass characteristics both in a horizontal direction and in a vertical direction, as will be described later.

The enlargement-decimation processor 8 is adapted to perform, by image processing, an electronic zoom process in which a magnification of a shot image is changed (enlarged or reduced). In a case in which the enlargement-decimation processor 8 reduces an image, the enlargement-decimation processor 8 performs a pixel decimation process. In a case in which the enlargement-decimation processor 8 enlarges an image, the enlargement-decimation processor 8 performs a pixel interpolation process.

The sharpness correction processor 9 is adapted to correct sharpness of an image by image processing. In a case in which a magnification of a shot image is changed by image processing, the sharpness correction processor 9 performs a process of changing sharpness correction characteristics in accordance with the magnification, as will be described later. The sharpness correction processor 9 may have a function as an aliasing detection-prediction section 14 as well. The aliasing detection-prediction section 14 may detect or predict generation of a false signal caused by aliasing by, for example, a high-pass filter.

The control microcomputer 13 is adapted to perform centralized control of respective circuit blocks. The OLPF controller 5 is adapted to control low-pass characteristics of the variable optical low-pass filter 30 in accordance with an instruction from the operation section 20 or the control microcomputer 13. In a case in which a magnification of a shot image is changed by image processing, the control microcomputer 13 and the OLPF controller 5 performs control to change the low-pass characteristics of the variable optical low-pass filter 30 in accordance with the magnification, as will be described later.

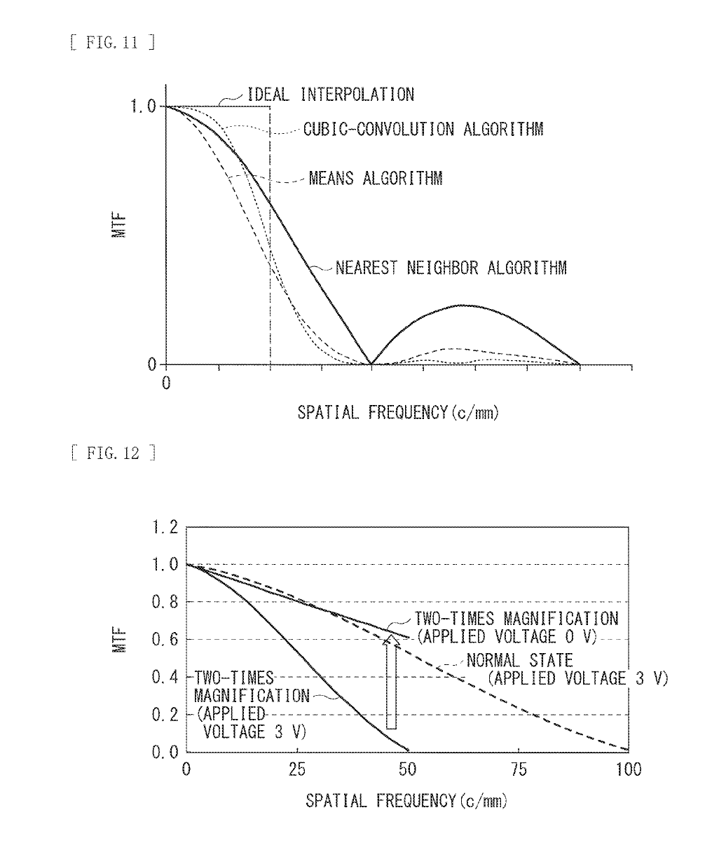

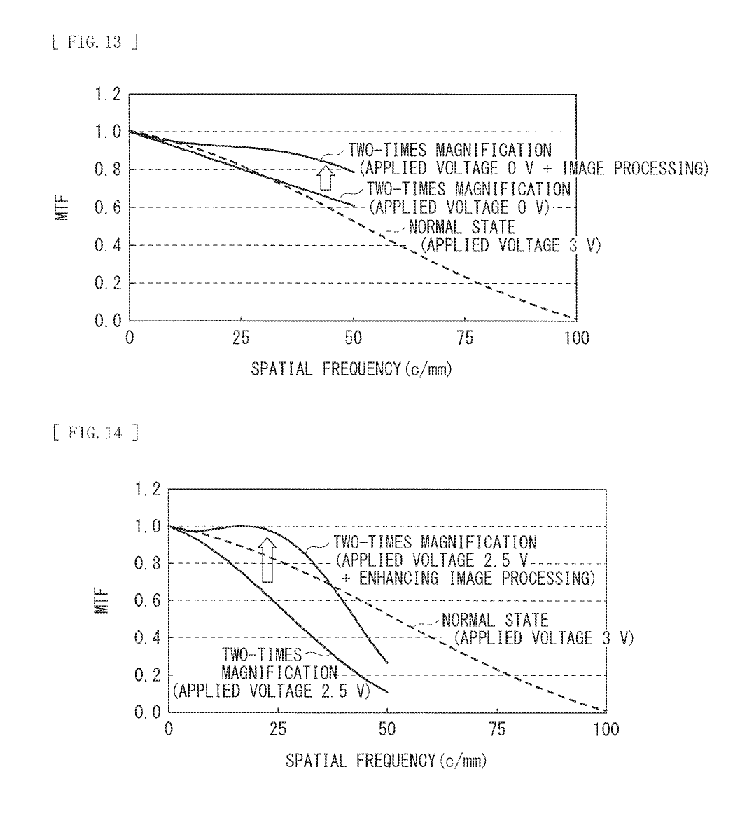

For example, in a case in which an image is enlarged by image processing and occurrence of aliasing is not detected or predicted, the control microcomputer 13 and the OLPF controller 5 may perform control to cause the low-pass characteristics of the variable optical low-pass filter 30 to be weaker than in a case in which the magnification is one time, as illustrated in FIG. 12 and FIG. 13 to be described later. For example, in a case in which an image is enlarged by image processing and occurrence of aliasing is detected or predicted, the control microcomputer 13 and the OLPF controller 5 may perform control to cause the low-pass characteristics of the variable optical low-pass filter 30 to be stronger than in a case in which the occurrence of aliasing is not detected or predicted, as illustrated in FIG. 14 to be described later. For example, in a case in which an image is enlarged by image processing, the control microcomputer 13 and the OLPF controller 5 may perform control to cause the low-pass characteristics of the variable optical low-pass filter 30 to be weaker than before the image is enlarged, as illustrated in FIG. 12 to be described later. Moreover, for example, in a case in which an image is reduced by image processing, the control microcomputer 13 and the OLPF controller 5 may perform control to cause the low-pass characteristics of the variable optical low-pass filter 30 to be stronger than before the image is reduced, as illustrated in FIG. 16 to be described later.

[1.2 Configuration Example of External Device Processing Raw Data]

FIG. 2 illustrates a configuration example of an external device 103 that processes Raw data. FIG. 1 illustrates a configuration in which various kinds of image processing are performed on image data in the camera 100; however, the camera 100 may include a Raw data recorder 109, as illustrated in FIG. 2. Data indicating low-pass characteristics at the time of image shooting may be recorded as metadata 102 together with Raw data 101, and the external device 103 may perform image processing. A function of image processing in the external device 103 may be achieved by an application on a PC (personal computer), for example. It is to be noted that, in the camera 100, processes to be performed in the image processor 7, the enlargement-decimation processor 8, and the sharpness correction section 9 are not applied when the Raw data is recorded (a signal passes through these components).

The external device 103 includes an image processor 104, an enlargement-decimation processor 105, a sharpness correction processor 106, and a compression-recording processor 107.

In the external device 103 illustrated in FIG. 2, each circuit block having the same name as one of the circuit blocks in the camera 100 in FIG. 1 basically has the same process function. Image data processed by the external device 103 is recorded as an output file 108.

[1.3 Configuration and Principle of Variable Optical Low-pass Filter]

The configuration and principle of the variable optical low-pass filter 30 are described more specifically with reference to FIGS. 3 to 6.

(Configuration Example of Variable Optical Low-pass Filter 30)

FIG. 3 illustrates a configuration example of the variable optical low-pass filter 30. The variable optical low-pass filter 30 includes a first birefringent plate 31, a second birefringent plate 32, a liquid crystal layer 33, a first electrode 34, and a second electrode 35. The variable optical low-pass filter 30 has a configuration in which the liquid crystal layer 33 is interposed between the first electrode 34 and the second electrode 35 and is further interposed from outside between the first birefringent plate 31 and the second birefringent plate 32. The first electrode 34 and the second electrode 35 are adapted to apply an electrical field to the liquid crystal layer 33. It is to be noted that the variable optical low-pass filter 30 may further include, for example, an alignment film that controls alignment of the liquid crystal layer 33. Each of the first electrode 34 and the second electrode 35 is configured of one sheet-like transparent electrode. It is to be noted that one of the first electrode 34 and the second electrode 35 or both may be configured of a plurality of partial electrodes.

The first birefringent plate 31 is disposed on light incident side of the variable optical low-pass filter 30, and an outer surface of the first birefringent plate 31 may serve as a light incident surface, for example. Incident light L1 is light that enters the light incident surface from subject side. The second birefringent plate 32 is disposed on light exit side of the variable optical low-pass filter 30, and an outer surface of the second birefringent plate 32 may serve as a light exit surface, for example. Transmission light L2 of the variable optical low-pass filter 30 is light that exits from the light exit surface to outside.

Each of the first birefringent plate 31 and the second birefringent plate 32 has birefringence, and has a uniaxial crystal structure. Each of the first birefringent plate 31 and the second birefringent plate 32 has a function of performing ps separation of circularly polarized light with use of birefringence. Each of the first birefringent plate 31 and the second birefringent plate 32 may be made of, for example, crystal, calcite, or lithium niobate.

The liquid crystal layer 33 may be made of, for example, a TN (Twisted Nematic) liquid crystal. The TN liquid crystal has optical activity causing the polarization direction of light passing therethrough to be rotated along rotation of the nematic liquid crystal.

Since the basic configuration in FIG. 3 makes it possible to control the low-pass characteristics in the specific one-dimensional direction, in the present embodiment, two variable optical low-pass filters 30 in FIG. 3 serving as the first variable optical low-pass filter 2 and the second variable optical low-pass filter 3 are mounted to control the low-pass characteristics in the horizontal direction and the vertical direction.

(Principle of Variable Optical Low-pass Filter 30)

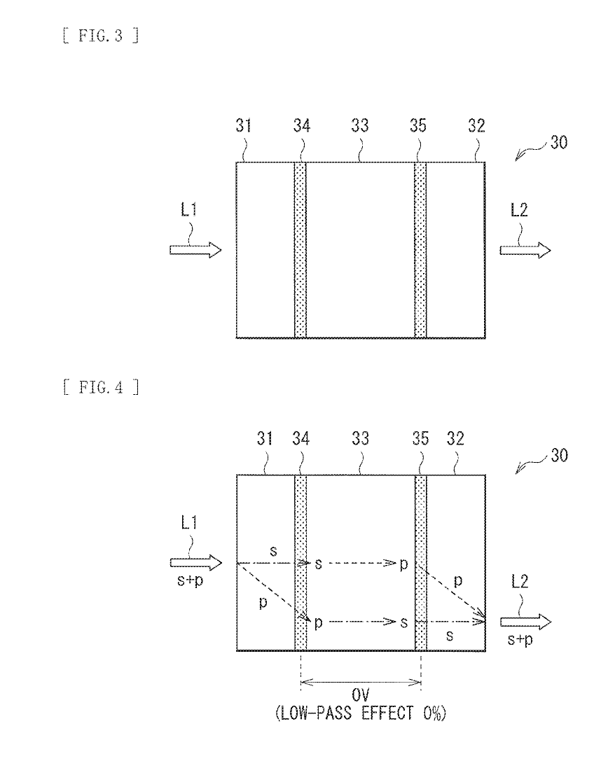

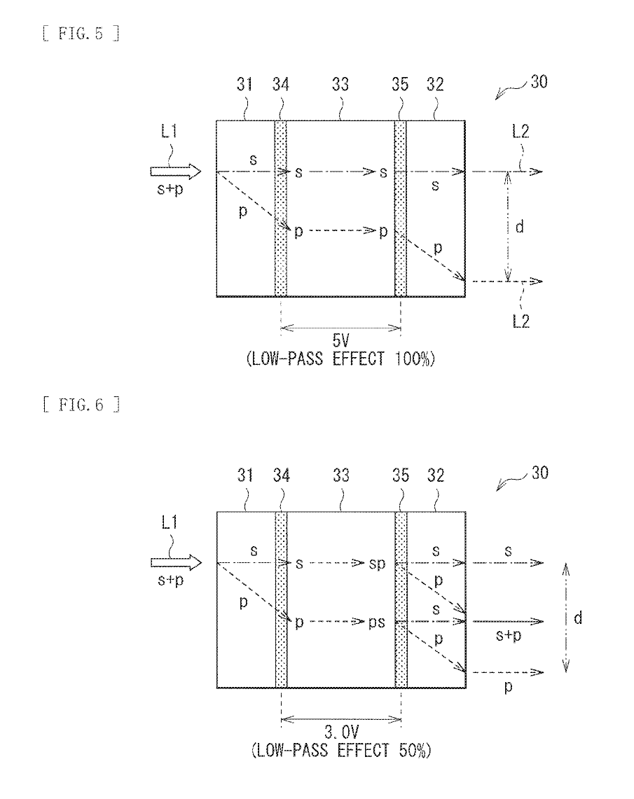

Description is given of the principle of the variable optical low-pass filter 30 with reference to FIGS. 4 to 6. FIG. 4 illustrates an example of a state in which a low-pass effect of the variable optical low-pass filter illustrated in FIG. 3 is 0%. FIG. 5 illustrates an example of a state in which the low-pass effect is 100%. FIG. 6 illustrates an example of a state in which the low-pass effect is 50%. It is to be noted that FIGS. 4 to 6 each illustrate an example in a case in which an optical axis of the first birefringent plate 31 is parallel to an optical axis of the second birefringent plate 32. Moreover, a voltage value illustrated in each of FIGS. 4 to 6 is an example, and is not limited thereto. The same applies to numerical values such as a voltage value illustrated in other following drawings.

In the variable optical low-pass filter 30, it is possible to control a polarization state of light to continuously change low-pass characteristics. In the variable optical low-pass filter 30, changing an electrical filed to be applied to the liquid crystal layer 33 (an applied voltage between the first electrode 34 and the second electrode 35) makes it possible to control the low-pass characteristics. For example, the low-pass effect is zero (equivalent to passing through) in a state in which the applied voltage is 0 V as illustrated in FIG. 4, and the low-pass effect is at the maximum (100%) in a state in which 5 V is applied as illustrated in FIG. 5. Moreover, the low-pass effect is in an intermediate state (50%) in a state in which 3 V is applied as illustrated in FIG. 6. Characteristics when the low-pass effect is at the maximum are determined by characteristics of the first birefringent plate 31 and the second birefringent plate 32.

In the respective states in FIGS. 4 to 6, the incident light L1 is separated by the first birefringent plate 31 into an s-polarized component and a p-polarized component.

In the state illustrated in FIG. 4, optical rotation in the liquid crystal layer 33 is 90°, which causes the s-polarized component and the p-polarized component to be respectively converted into a p-polarized component and an s-polarized component in the liquid crystal layer 33. Thereafter, the second birefringent plate 32 combines the p-polarized component and the s-polarized component into the transmission light L2. In the state illustrated in FIG. 4, a separation width d between the ultimate s-polarized component and the ultimate p-polarized component is zero, and the low-pass effect is zero accordingly.

In the state illustrated in FIG. 5, the optical rotation in the liquid crystal layer 33 is 0°, which causes the s-polarized component and the p-polarized component to pass through the liquid crystal layer 33 without being converted. Thereafter, a separation width between the p-polarized component and the s-polarized component is increased by the second birefringent plate 32. In the state illustrated in FIG. 5, the separation width d between the s-polarized component and the p-polarized component in the ultimate transmission light L2 is at the maximum, and the low-pass effect is at the maximum (100%) accordingly.

In the state illustrated in FIG. 6, the optical rotation in the liquid crystal layer 33 is 45°, which causes the s-polarized component including an s-polarized component and a p-polarized component to pass through the liquid crystal layer 33, and thereafter be separated into an s-polarized component and a p-polarized component by the second birefringent plate 32. Likewise, the p-polarized component including an s-polarized component and a p-polarized component is caused to pass through the liquid crystal layer 33, and thereafter be separated into an s-polarized component and a p-polarized component by the second birefringent plate 32. The ultimate transmission light L2 includes the s-polarized component and the p-polarized component separated by the separation width d, and a combined component of the p-polarized component and the s-polarized component, and the low-pass effect is in an intermediate state (50%).

[1.4 Degradation in Image Quality in Image Processing and Solution thereto]

There is known a technology to optimize characteristics for each of cases with different pixel pitches such as still image shooting, moving image shooting, and live viewing by changing a low-pass effect for each of the cases with use of a technology of the variable optical low-pass filter 30 that is allowed to continuously change the low-pass effect. However, measures are not taken against degradation in sharpness caused at the time of image enlargement, thereby causing degradation in image quality.

In contrast, reduction of an image also causes degradation in image quality by aliasing caused in an image processing stage for decimation of the image. A filter by image processing makes it possible to reduce the aliasing; however, it is necessary to perform a convolution arithmetic operation of a plurality of pixel signals and a signal providing filter characteristics, which takes a certain arithmetic operation time and needs costs for achievement. Likewise, in related art, an optical low-pass filter is mounted to prevent aliasing; however, the optical low-pass filter has fixed characteristics optimized for a state in which reduction is not performed, and does not at all make a contribution when an image is reduced.

Using the variable optical low-pass filter 30 makes it possible to solve the issues mentioned above (a specific solving method will be described separately); however, in a case in which manual focus adjustment is performed, a trade-off relation between sharpness and a false signal is not established at the time of image shooting, thereby causing another issue. More specifically, when manual focus adjustment is performed, a focal position where an image is the sharpest is found, but at this occasion, as sharpness is higher, a difference between when the image is in focus and when the image is out of focus is larger, which makes focus adjustment easier. Further, the largest number of false signals is generated when the image is in focus; therefore, a position where the image is in focus is clearly found when the false signal is not suppressed.

Moreover, in related art, there is a camera that records so-called Raw data 101 without performing image processing mentioned above in the camera and performs enlargement and sharpness correction by application software on a PC. However, even such a camera has a different issue. In a case in which the Raw data 101 is recorded in a state in which the low-pass characteristics of the variable optical low-pass filter 30 are changed and sharpness correction at the time of enlargement is optimized by an application on the PC, the application on the PC is not able to know the low-pass characteristics, and is not allowed to perform appropriate processing. Although a means of embedding various kinds of metadata in the Raw data 101 is known, data indicating the low-pass characteristics of the variable optical low-pass filter 30 is not recorded, thereby causing the issue mentioned above.

Further, in a case in which the variable optical low-pass filter 30 is used, a means of enlarging and displaying a part of an image with the same pixel pitch as that at the time of image shooting makes it possible to manually set the effect while actually confirming generation of a false signal and degradation in sharpness to achieve an optimum trade-off state. However, such a technique has not been known.

FIG. 7 illustrates an example of change in MTF characteristics in a case in which a voltage to be applied to the variable optical low-pass filter 30 is changed. In FIG. 7, a horizontal axis indicates spatial frequency (c/mm (cycle/mm)) and a vertical axis indicates an MTF value. The same applies to the following other drawings indicating MTF characteristics.

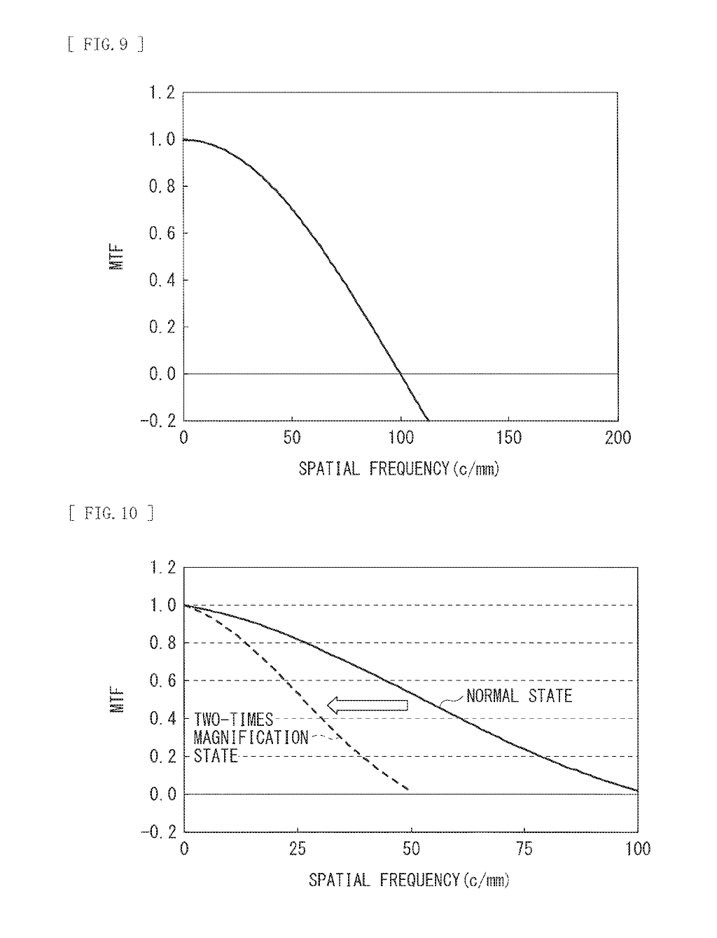

FIG. 8 illustrates an example of change in MTF characteristics by an applied voltage in a case in which the variable optical low-pass filter 30 illustrated in FIG. 3 is combined with the imaging lens 1A. The MTF characteristics at 0 V are in a passing-through state without a low-pass effect, and are completely the MTF characteristics of the imaging lens 1A.

FIG. 9 illustrates an example of the MTF characteristics of a typical optical low-pass filter. In this case, only specific low-pass characteristics determined at design time are provided.

Description is given of degradation in MTF characteristics caused at the time of image enlargement with reference to FIGS. 10 and 11. FIG. 10 illustrates an example of change in MTF characteristics at the time of image enlargement. FIG. 11 illustrates an example of change in MTF characteristics by different pixel interpolation algorithms at the time of image enlargement.

In a case in which an image is enlarged by image processing, degradation in sharpness is caused by the following two factors. One of the factors is an influence of enlargement itself. In a case in which image data is enlarged, even if image data is enlarged ideally, frequency characteristics of the image data are shifted to low frequency side by an extent corresponding to such enlargement. FIG. 10 illustrates MTF characteristics in a normal (one-time magnification) state and a two-times magnification state. When the image is enlarged, sharpness is degraded, as compared with an original image.

The second factor is degradation in frequency characteristics by a pixel interpolation algorithm. When an image is enlarged, it is necessary to produce new pixel information between a pixel and another pixel by any method. In general, the pixel information is produced by interpolation from peripheral pixels. In a case in which pixels are generated by interpolation, degradation in frequency characteristics occurs, and the characteristics are determined by an interpolation algorithm. FIG. 11 illustrates frequency characteristics of typical interpolation algorithms including a nearest neighbor algorithm, a means algorithm, and a cubic-convolution algorithm. As can be seen from the drawing, the frequency characteristics of any of the algorithms are degraded.

FIG. 12 illustrates an example in which degradation in the MTF characteristics caused by image enlargement are corrected by changing the low-pass characteristics of the variable optical low-pass filter 30. As illustrated in FIGS. 10 and 11, in a case in which an image is enlarged, the influence of enlargement itself and an influence of the interpolation algorithm cause degradation in MTF characteristics. Image processing makes it possible to partially correct the degradation in MTF characteristics; however, when the degradation in MTF characteristics are corrected by the image processing, signals other than the image such as noise are enhanced at the same time, thereby causing degradation in image quality.

In the camera 100 including the variable optical low-pass filter 30, when the low-pass characteristics of the variable optical low-pass filter 30 are set to be weaker than in the normal state (one-time magnification), it is possible to correct sharpness while suppressing an increase in noise. For example, an applied voltage to the variable optical low-pass filter 30 may be set from 3 V to 0 V. When the low-pass effect is weakened, aliasing may occur at the time of image shooting, but whether aliasing occurs is largely dependent on a subject. In contrast, degradation in sharpness caused by enlargement always occurs at the time of enlargement. Accordingly, weakening the low-pass effect to correct sharpness makes it possible to stochastically achieve an image with high image quality.

FIG. 13 illustrates an example in which degradation in MTF characteristics caused by image enlargement are corrected with combined use of change in the low-pass filter characteristics of the variable optical low-pass filter 30 and image processing (sharpness correction). As described in FIG. 12, setting the characteristics of the variable optical low-pass filter 30 to be weak makes it possible to correct degradation in MTF characteristics caused at the time of image enlargement. However, as can be seen from FIG. 12, in an interpolation process, information in a high frequency portion is still missing, and information the subject originally has is not produced in the portion. Accordingly, even though the variable optical low-pass filter 30 is weakened, an impression that sharpness of an image is insufficient is given frequently. Therefore, it is effective to further enhance sharpness of the image to compensate for a sense of insufficiency of sharpness. For further enhancement, a means of further weakening the variable optical low-pass filter 30 is applicable, but this method is not allowed to correct sharpness more than in a state without a low-pass effect (a voltage of 0 V). Accordingly, it is effective to also use a sharpness correction process by image processing by the sharpness correction processor 9 or the sharpness correction processor 106. An optimum correction amount is changed by magnification; therefore, an idea that the variable optical low-pass filter 30 performs correction in a range covered thereby in accordance with the magnification, and correction is performed by image processing so as to compensate for the remaining range is effective in terms of reducing an increase in noise. A process such as a process by a spatial filter is applicable to sharpness correction by image processing, as will be described later.

FIG. 14 illustrates an example in which a further adaptive operation is performed by detection or prediction of whether aliasing occurs at the time of image shooting to improve image quality. FIG. 14 illustrates an example in a case in which the low-pass effect and sharpness correction are enhanced, as compared with correction in FIG. 13. In FIG. 13, description has been given of a case in which both adjustment of the low-pass effect of the variable optical low-pass filter 30 and correction by image processing are used in order to correct degradation in sharpness at the time of enlargement. At that occasion, description has been given that correction by image processing causes an increase in noise and it is therefore effective to give a higher priority to a method of weakening the low-pass effect. In contrast, description has been given that when the low-pass effect is weakened, generation of the false signal by aliasing is a concern. A means of detecting or predicting generation of the false signal makes it possible to improve this trade-off. In other words, in a case in which the false signal is detected or predicted when sharpness correction is performed, the effect of the variable optical low-pass filter 30 is enhanced to suppress the false signal, and correction by image processing is enhanced by an extent corresponding to degradation in sharpness caused by enhancement of the effect, as illustrated in FIG. 14. On the other hand, in a case in which the false signal is not detected or predicted, the low-pass effect is weakened, and sharpness correction by image processing is weakened, as illustrated in FIG. 13. When a periodic false signal such as moire is generated, the frequency of the false signal is shifted to lower side at the time of enlargement to make an influence of the false signal noticeable; therefore, such an adaptive process is effective. A specific means of detecting or predicting the false signal will be described in the following description of a still image shooting process.

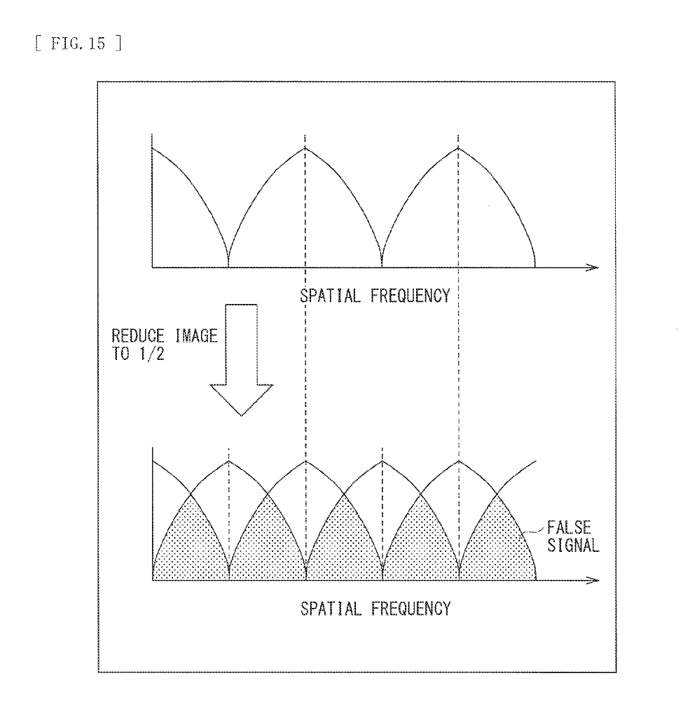

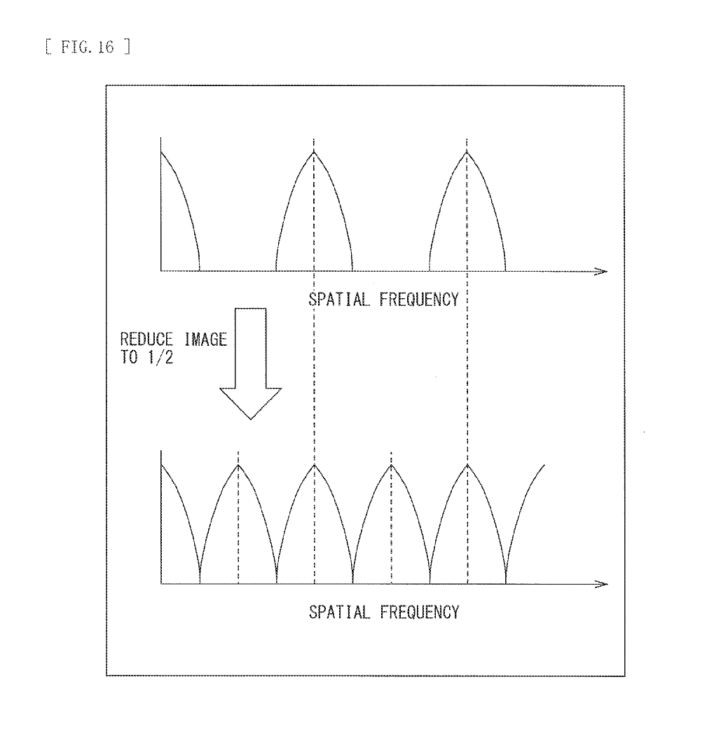

FIG. 15 and FIG. 16 each illustrate an example of occurrence of aliasing caused at the time of image reduction and an example in which the occurrence of aliasing is suppressed by the variable optical low-pass filter 30. In FIGS. 15 and 16, an upper part illustrates a state before reduction of an image, and a lower part illustrates a state in which the image is reduced to ½. The reduction of the image means increasing a sampling interval of the image, and a false signal by aliasing is generated at this occasion as illustrated in FIG. 15. In general, the low-pass filter by image processing is applied before reduction to remove a high frequency component. This process is performed by a spatial filter similar to that in sharpness correction; however, it is necessary to perform a two-dimensional convolution arithmetic operation of a signal of the low-pass filter and a pixel value, which takes a certain process time.

Application of the low-pass characteristics in the variable optical low-pass filter 30 at the time of image reduction instead of image processing makes it possible to remove a high frequency component that causes aliasing, as illustrated in FIG. 16. The low-pass characteristics at this time enhance the effect more than in the normal state. In a case in which the low-pass effect is applied by the variable optical low-pass filter 30, a filter process by image processing is unnecessary, which makes it possible to improve process speed. Thus, a method of speeding up the process with use of the variable optical low-pass filter 30 is specifically effective, for example, in a case in which a high-speed continuous image shooting mode is provided to the camera 100 in addition to a normal mode. In the high-speed continuous image shooting mode, an image size is reduced, but continuous image shooting speed is increased. Moreover, in a case with the camera 100 that does not have an enlargement mode and allows for reduction only, it is possible to omit a low-pass processing circuit by image processing, thereby reducing costs of the camera 100.

### 2. Operation

### [2.1 Entire Control Operation of Camera]

FIG. 17 illustrates an example of a flow of entire control of the camera. The control microcomputer 13 performs processes in step S1 to step S13 illustrated in FIG. 17 as an entire control process of the camera by itself or by controlling other circuit blocks.

After starting up the camera 100, the control microcomputer 13 determines a state of the main switch (main SW) in the step S1. When the main switch is in an on state, the process goes to step S2, and when the main switch is in an off state, determination of the state of the switch is repeated. In the step S2, necessary initialization is performed.

In step S3, the control microcomputer 13 performs display of a live view image and a necessary process in a case in which manual focus adjustment are performed by the focus adjustment operation section 23 and in a case in which an image is enlarged and the effect of the variable optical low-pass filter 30 is manually set. Details will be given later.

In step S4, the control microcomputer 13 determines the state of the main SW again. When the main SW is still in the on state, the process goes to the next step S5. When the main SW is in the off state, the process goes to step S13, and an end process is performed to turn the camera 100 to a standby state, and thereafter, the process returns to the step S1.

In the step S5, the control microcomputer 13 detects the state of the switch SW1 that is turned to the on state in a state in which the shutter button 21 is pressed halfway, and when the switch SW1 is in the on state, the process goes to an image shooting preparation operation in step S6. When the switch SW1 is not in the on state, the process returns to the step S3, and the live view process (1) is repeated.

In the step S6, the control microcomputer 13 performs a necessary preparation process for image shooting. In the present embodiment, description is given of only a focus adjustment process by automatic focusing that is a main process herein. The control microcomputer 13 provides a predetermined instruction to the lens controller 4, and repeats reading of an image while continuously changing a focus position of the imaging lens 1A. The control microcomputer 13 calculates a contrast evaluation value of the subject from read image data to determine a position where the evaluation value is at the maximum, and fixes the focus position of the lens to the determined position. This is a typical contrast AF (autofocus) system in a digital camera.

In step S7, the control microcomputer 13 performs a process similar to that in the step S3 to display the live view image again. The process is different from that in the step S3 in that an exposure arithmetic operation is not performed here in order to fix exposure in a state in which the switch SW1 is in the on state.

In step S8, the control microcomputer 13 determines whether the switch SW2 is in the on state or in the off state. The switch SW2 detects that shutter button 21 is pressed. When the switch SW2 is in the on state, the process by the control microcomputer 13 goes to an image shooting operation in step S9 and later steps. When the switch SW2 is in the off state, the control microcomputer 13 determines whether the switch SW1 is turned to the off state in step S11, and when the SW1 is turned to the off state, the process is returned to the step S3, and the control microcomputer 13 repeats the live view process (1) and later processes. When the switch SW1 is still in the on state, the process is returned to the step S7, and the control microcomputer 13 repeats a live view process (2) and later processes.

In step S9, the control microcomputer 13 determines a recording mode of the camera 100. In a case in which the recording mode is a still image mode, the process by the control microcomputer 13 goes to a still image shooting process in step S10, and in a case in which the recording mode is a moving image mode, the process by the control microcomputer 13 goes to a moving image shooting process in step S12. The still image shooting process in the step S10 and the moving image shooting process in the step S12 will be described in detail later. The process returns to the step S3 after completion of both the processes, and the control microcomputer 13 repeats a sequence of the operations.

[2.2 Live View Process]

FIG. 18 illustrates an example of a flow of the live view process (1). The control microcomputer 13 performs processes in step S100 to step S106 illustrated in FIG. 18 as the above-described live view process (1) in the step S3 by itself or by controlling other circuit blocks.

First, in the step S100, the control microcomputer 13 reads live view image data from the imaging element 6. The live view image data needs only the number of pixels necessary to be displayed on the display panel 11; therefore, data in which a plurality of pixels in a vertical direction is added and pixels are decimated inside the imaging element 6 is read out.

Next, in step S101, the control microcomputer 13 performs an exposure (AE) arithmetic operation and a white balance (AWB) arithmetic operation from the read image data. The control microcomputer 13 determines an f number to be set to the lens controller 4 and shutter speed to be set to the imaging element 6 from a result of the exposure arithmetic operation to appropriately control exposure (this result is reflected from an image to be next read). A white balance gain determined by the white balance arithmetic operation is applied to the next image processing stage.

In step S102, the image processor 7 performs appropriate processing on the read image data. The image processing includes, for example, but not limited to, white balance, demosaicing, grayscale conversion, color conversion, and noise reduction, all of which are general processes for a digital camera, and are not described here. In a case in which an instruction for electronic zoom is provided, an enlargement process is performed on the image data in an electronic zoom block (the enlargement-decimation processor 8). Next, sharpness correction is performed in the sharpness correction processor 9. Details of the electronic zoom and the sharpness correction will be described in the following description of the still image shooting process (FIG. 19). The image having been subjected to these processes is outputted to the display panel 11, and the live view image is displayed.

In step S103, the control microcomputer 13 determines whether the focus mode of the camera 100 is set to a manual focus mode. In a case in which the camera 100 is set to the manual focus mode, the process by the control microcomputer 13 goes to step S104, and in a case in which the camera 100 is not set to the manual focus mode, the live view process (1) is ended.

In the step S104, the control microcomputer 13 performs a manual focus adjustment operation on the basis of an instruction from the focus adjustment operation section 23. In this mode, image data having the number of pixels that are allowed to be displayed on the display panel 11 are read from the imaging element 6 without partially decimating the image data. A partially enlarged image of the subject is displayed on the display panel 11 to achieve a state suitable for focus adjustment. In this mode, the lens controller 4 operates to change a focus position, for example, by a rotation amount of a focus adjustment ring provided to a lens barrel as the focus adjustment operation section 23, and a user is allowed to perform focus adjustment by rotating the ring with his hand while seeing the displayed image. Moreover, although specific description of a position read from the imaging element 6 is omitted, the position is changeable by a switch that is allowed to specify a direction selected from four directions including an upward direction, a downward direction, a rightward direction, and a leftward direction. In this mode, the control microcomputer 13 instructs the OLPF controller 5 to set a voltage to be applied to the variable optical low-pass filter 30 to 0 V. In other words, the low-pass effect is set to be zero. Thus, a difference between when the image is in focus and when the image is out of focus is increased, which makes focus adjustment easier. Further, the largest number of false signals by aliasing is generated when the image is in focus; therefore, setting the low-pass effect to zero makes it possible to perform focus adjustment on the basis of the generation of the false signal and to perform focus adjustment more easily.

It is to be noted that the above description involves an example in a case in which an enlarged image of the subject is displayed during manual focus adjustment; however, it is possible to perform focus adjustment without displaying the enlarged image. Even in this case, it may preferable to perform control that causes the low-pass effect at the time of focus adjustment to be weaker than before the focus adjustment, which makes focus adjustment easier.

In step S105, the control microcomputer 13 determines whether a low-pass effect adjustment mode is a manual mode. In the present embodiment, the low-pass effect adjustment mode includes three kinds of modes, i.e., a normal mode, an automatic mode, and a manual mode. In a case in which the low-pass effect adjustment mode is the manual mode, the process by the control microcomputer 13 goes to step S106. In a case in which the low-pass effect adjustment mode is any mode other than the manual mode, the live view process (1) is ended.

In the step S106, the control microcomputer 13 performs an operation in the manual low-pass effect adjustment mode. In this mode, after the focus adjustment operation section 23 performs manual focus adjustment, a variable OLPF effect setting button 22 having two directions, i.e., a strong mode and a weak mode is operated while the displayed image is seen. This makes it possible to set an appropriate low-pass effect. In the live view image, an image having been subjected to decimation in the above-described manner for framing of the camera 100 is read, and the entirety of the image is displayed. A false signal generated at this occasion is different from a false signal appearing in an image finally recorded, since the pixel pitch is different. In this mode, as with the manual focus mode, the image is read and displayed without being decimated. The entirety of the image is not allowed to be displayed; therefore, as with the manual focus mode, a position where the image is to be displayed is allowed to be changed by a switch having four directions. It is to be noted that the present embodiment involves a configuration in which the low-pass effect is adjusted after manual focus adjustment is performed; however, the effect may be adjusted after the above-described automatic focus operation is performed once after switching to this mode. Moreover, as long as the image is not decimated or reduced as described above, it may be possible to further increase a magnification of the image to display the enlarged image. Such a configuration makes a more specific check of the subject easier.

[2.3 Still Image shooting Process]

FIG. 19 illustrates an example of a flow of the still image shooting process. The control microcomputer 13 performs processes in step S200 to S209 illustrated in FIG. 19 as the still image shooting process by itself or by controlling other circuit blocks.

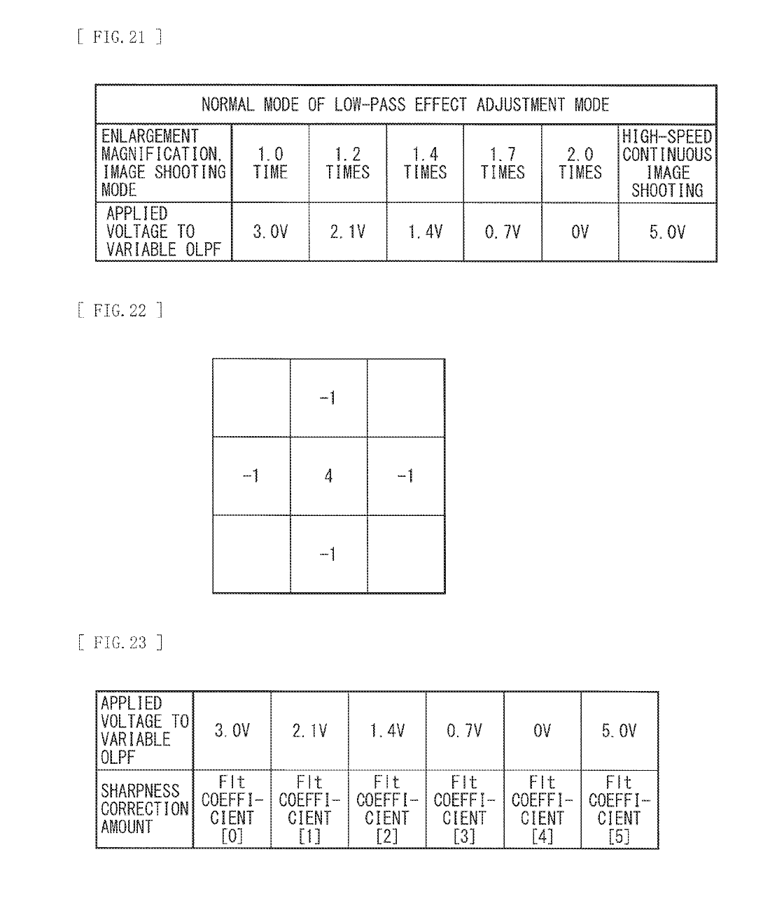

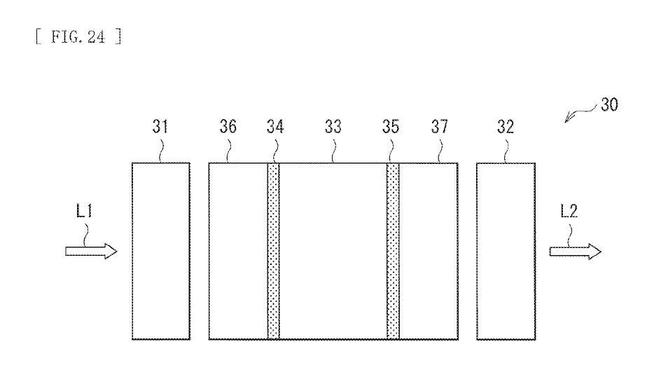

Is it to be noted that the following description is given with reference to FIGS. 21 to 23 as appropriate. FIG. 21 illustrates a parameter table summarizing an applied voltage to the variable optical low-pass filter 30 that is used when the low-pass adjustment mode is the normal mode. FIG. 22 illustrates a high-pass filter for detection of a high frequency component that is used when the low-pass effect adjustment mode is the automatic mode. FIG. 23 illustrates a parameter table summarizing a sharpness correction amount (a spatial filter coefficient) in accordance with an applied voltage to the variable optical low-pass filter 30.

In FIG. 19, the control microcomputer 13 first determines a voltage to be applied to the variable optical low-pass filter 30 in the step S200, and provides an instruction to the OLPF controller 5 to apply the voltage to the variable optical low-pass filter 30. The applied voltage is determined as follows.

In the present embodiment, as described in the description of the above live view process (1), the low-pass effect adjustment mode includes three modes, i.e., the normal mode, the automatic mode, and the manual mode. In the normal mode, the applied voltage is determined in accordance with a table indicating an applied voltage for each of the modes. The table is held in the camera 100 in advance. In the automatic mode, a temporary image is shot, and the shot image is analyzed to determine the low-pass effect. The manual mode is a mode in which the effect is manually adjusted, and the manual mode has been already described in the description of the live view process (1).

In the step S200, the control microcomputer 13 first determines the above-described low-pass effect adjustment mode, and the process by the control microcomputer 13 goes to one of processes corresponding to the low-pass effect adjustment modes. In the normal mode, the control microcomputer 13 determines the applied voltage in accordance with setting of the camera 100, i.e., the electronic zoom mode and the high-speed continuous image shooting mode with reference to the parameter table (FIG. 21) held in the camera 100. In a case with the electronic zoom mode, the voltage is discretely recorded with respect to magnification, as illustrated in the table. Accordingly, in a case in which the magnification is intermediate, the control microcomputer 13 reads a voltage in a corresponding section from the table, and interpolates the voltage to determine the applied voltage. In the high-speed continuous shooting mode, the control microcomputer 13 reads one kind of applied voltage corresponding to an image decimation state.

In the automatic mode, the low-pass effect is determined by the shot temporary image. First, a voltage of 0 V (the state without a low-pass effect) is applied to the variable optical low-pass filter 30, and the temporary image is captured from the imaging element 6 in this state. After the read image is subjected to the same process as that in the normal state in the image processor 7, the image passes through the enlargement-decimation processor 8 without being subjected to any process, and is subjected to a high frequency component detection process by a high-pass filter in the aliasing detection-prediction section 14 of the sharpness correction processor 9.

The high-pass filter may be, for example, a filter illustrated in FIG. 22, and after the process is applied, the remaining high frequency component is integrated. An applied voltage with respect to the integrated value of the high frequency component is determined in advance, and the voltage to be applied to the variable optical low-pass filter 30 is determined in accordance therewith. In other words, in a subject having more high frequency components, there is a possibility that generation of a false signal by aliasing occurs more frequently; therefore, the low-pass effect is enhanced. In contrast, in a subject having few high frequency components, a possibility that the false signal is generated is low; therefore, the low-pass effect is weakened. It is to be noted that the present embodiment involves a configuration in which the generation of the false signal is predicted by detection of the high frequency component; however, in addition thereto, for example, two kinds of images in a state in which the low-pass effect is not applied and in a state in which the low-pass effect is applied may be captured to detect generation of the false signal from a difference between the images. Moreover, a technique in which the captured images are subjected to Fourier transform to detect a periodic component such as moire is effective.

In the manual mode, the applied voltage to the variable optical low-pass filter 30 has been already determined as described in description of the live view process (1), and the determined applied voltage is used.

In the normal mode and the automatic mode, the control microcomputer 13 instructs the OLPF controller 5 about the applied voltage determined corresponding to each of the low-pass effect adjustment modes at the end of the step S200 to apply the effect.

In the following step S201, image data is read from the imaging element 6. In step S202, the control microcomputer 13 determines whether the image shooting mode is a Raw image shooting mode. In a case in which the image shooting mode is the Raw image shooting mode, the process goes to step S209, and a Raw image before being subjected to image processing in the camera 100 is stored in a file, and the process is ended. At this occasion, the applied voltage to the variable optical low-pass filter 30 determined in the step S200 serving as data indicating low-pass characteristics is recorded as the metadata 102 in the file together with other image shooting data. In a case in which the image shooting mode is not the Raw image shooting mode, the process goes to step S203.

In the step S203, the read image data is subjected to processing such as white balance, demosaicing, grayscale conversion, color conversion, and noise reduction in the image processor 7. In the following step S204, the control microcomputer 13 determines the image shooting mode, and in a case in which the image shooting mode is the electronic zoom mode, the process goes to step S205, and in a case in which the image shooting mode is the high-speed continuous image shooting mode, the process goes to step S206. In a case in which the image shooting mode is the normal mode, the process goes to step S207.

In the step S205, the control microcomputer 13 performs an image enlargement process in accordance with electronic zoom setting. In the process, necessary conversion is performed by specifying an input image size, an output image size, and enlargement magnification to the enlargement-decimation processor 8. At the time of electronic zoom, the same number of input pixels and the same number of output pixels as those in the normal state (one-time magnification) are specified, and the zoom magnification set by a user is set as enlargement magnification, which causes an image having a central part enlarged by an interpolation process to be outputted while keeping the image size. Interpolation of the image is performed by the cubic-convolution algorithm of which characteristics are illustrated in FIG. 11, for example. Details of the algorithm are kwon in literatures relating to various kinds of image processing, and are not described here.

In the step S206, the control microcomputer 13 performs a process in the high-speed continuous image shooting mode. In the high-speed continuous image shooting mode, a process of reducing the number of pixels is performed while keeping the magnification of the image to the one-time magnification. In other words, in the enlargement-decimation processor 8, the same number of pixels as that in the normal state is set as the number of input pixels, and a half value of each of horizontal and vertical sizes (¼ of the number of pixels) in the normal state is set as the number of output pixels. In this case, the enlargement magnification is automatically set by a ratio of the number of pixels. In the enlargement-decimation processor 8, the pixels are decimated more simply, for example, by the nearest neighbor algorithm at intervals corresponding to a ratio of the number of input pixels and the number of output pixels. Since the horizontal size and the vertical size are reduced by half, the pixels are decimated every other pixels. In general, when resampling is performed in such simple decimation, aliasing occurs to cause degradation in image quality. However, for example, the low-pass characteristics of the variable optical low-pass filter 30 are set to characteristics that are turned to zero at a half of the pixel pitch in the normal state, which makes it possible to achieve a decimated image with high image quality without occurrence of aliasing.

Next, in the step S207, sharpness correction is performed. The sharpness correction is performed by a 5×5 spatial filter, for example. A filter coefficient is determined in accordance with the low-pass characteristics (applied voltage) of the variable optical low-pass filter 30 determined in the step S200 with reference to a sharpness correction parameter table (FIG. 23) held in the camera 100, and the process is performed.

In the step S208, the control microcomputer 13 provides a necessary instruction to the compression-recording processor 10 to compress the image having been subjected to a sequence of the processes by, for example, a JPEG algorithm and record the compressed image on the recording medium 12. At this occasion, the metadata 102 such as image shooting conditions is recorded together, and the process is ended.

(Operation Example in Case in which External Device Processes Raw Data)

In FIG. 2, the Raw data 101 outputted from the camera 100 is read to the external device, and is subjected to image processing. The image processor 104 has a function equivalent to that of the image processor 7 in the camera 100, and performs the same process as that described in the step S203 in the above-described still image shooting process. The enlargement-decimation processor 105, the sharpness correction processor 106, and the compression-recording processor 107 each have the same function as that of a corresponding one of the circuit blocks in the camera 100 in FIG. 1, and each perform a process equivalent to that in the still image shooting process in the camera 100, as follows.

As a difference from the process in the camera 100, information recorded in the metadata 102 that is recorded in the Raw data 101 is used as mode setting of the camera 100 used for an enlargement-decimation process and enlargement magnification at the time of electronic zoom. Moreover, as the low-pass characteristics used for the sharpness correction process, the applied voltage recorded as the metadata 102 is used in a similar manner.

Image data having been subjected to the above-described processes in the external device 103 is recorded as the output file 108.

[2.4 Moving Image shooting Process]

FIG. 20 illustrates an example of a flow of the moving image shooting process. The control microcomputer 13 performs processes in steps S300 to S309 illustrated in FIG. 20 as the moving image shooting process by itself or by controlling other circuit blocks. In moving image shooting, each process having the same name as one of the processes described in the still image shooting process are basically the same process, and only differences are described below.

In the present embodiment, image data read from the image element are the same at the time of still image shooting and at the time of moving image shooting; however, in a case in which the image data is different and the pixel pitch at the time of moving image shooting is different from that at the time of still image shooting, the table used to determine the voltage to be applied to the variable optical low-pass filter 30 is replaced by a table for moving image shooting only in the step S300. It is necessary to read an image at high speed at the time of moving image shooting, which may cause pixels to be decimated in some cases. In such a case, the pixel pitch is changed.

As step S303, an AF-AE-AWB process is added to continuously perform focus adjustment, exposure control, and a white balance process during moving image shooting. The process here is a process optimized for moving image shooting. Examples of the process may include smoothing of change to prevent a determined exposure value from abruptly changing with respect to an immediately preceding frame.

At the time of moving image shooting, the high-speed continuous image shooting mode in still image shooting is excluded. Accordingly, in image shooting mode determination in step S305, whether the image shooting mode is the electronic zoom mode is determined only.

In a compression-recording process in step S308, a compression system and a file format are respectively changed to a compression system such as ITU-T H.264 and a moving image file format such as AVCHD that are suitable for moving images.

In the step S309, determination of end of moving image recording is added, and in a case in which recording is not ended, the process returns to the step S300, and a sequence of the processes is repeated. In a case in which end of recording is indicated, the moving image shooting process is ended. The end of moving image recording is indicated by temporarily turning off the switch SW2 of the shutter button 21 after start of the recording and then turning on the switch SW2 again.

### 3. Effects

According to the present embodiment, in a case in which a magnification of a shot image is changed by image processing, the low-pass characteristics of the variable optical low-pass filter 30 are changed in accordance with the magnification, which makes it possible to achieve an image with high image quality. Moreover, the following effects are achievable.

At the time of enlargement of an image that causes degradation in sharpness, the low-pass characteristics of the variable optical low-pass filter 30 are set to be weak, which makes it possible to achieve an image with high image quality in which degradation in sharpness is suppressed. Moreover, the low-pass characteristics of the variable optical low-pass filter 30 that are set at the time of enlargement of the image are adjusted to optimize the sharpness correction process by image processing, which makes it possible to achieve an image with higher image quality.

Further, in a case in which generation of moire by aliasing is not detected or predicted at the time of enlargement of the image, the low-pass characteristics of the low-pass variable optical low-pass filter 30 are set to be weak, which makes it possible to achieve an image with high image quality in which degradation in sharpness is suppressed.

Contrary to the above case, in a case in which the generation of aliasing is detected or predicted at the time of enlargement of the image, the low-pass characteristics of the variable optical low-pass filter 30 are set to be strong, thereby suppressing a false signal generated at the time of image shooting, and correction by image processing is performed in the sharpness correction processor 9 by an extent corresponding to the degradation in sharpness, which makes it possible to achieve an image with high image quality in which degradation in sharpness is suppressed while preventing the false signal from being converted into a lower frequency and being noticeable.

In any of the above cases, only in terms of preventing degradation in sharpness at the time of enlargement, it is possible to achieve a similar effect by not using the variable optical low-pass filter 30; however, in this case, a false signal by aliasing is generated to cause degradation in image quality in a different way. According to the present embodiment, it is possible to adaptively cope with degradation in image quality caused by the false signal at the time of normal image shooting and degradation in sharpness at the time of enlargement. This makes it possible to always take a photograph with high image quality.

Unlike an example in related art in which mechanical switching is performed between insertion and non-insertion of the optical low-pass filter, it is possible to adaptively cope with different degrees of degradation in sharpness by enlargement magnification, and even in a case in which enlargement is performed during moving image shooting, it is possible to cope with different degrees of degradation in sharpness without giving discontinuous change to a recorded image, which makes it possible to achieve a photograph (a moving image) with higher image quality.

In contrast, when an image is reduced, the low-pass characteristics corresponding to the pixel pitch at the time of reduction is applied to the variable optical low-pass filter 30. Even if a filter by image processing is not used, this makes it possible to achieve a reduced image with high image quality without occurrence of aliasing. Accordingly, it is possible to perform processing at high speed, to simplify a configuration of the camera 100, and to reduce costs.

Moreover, ease of manual focus adjustment and image quality at the time of recording are compatible, which makes it possible to achieve an image with higher image quality including an effect caused by improvement in focus accuracy.

Further, the variable optical low-pass filter 30 and the display panel 11 that enlarges and displays a part of an image with the same pixel pitch as that at the time of image shooting are combined, which makes it possible to manually set the effect while actually confirming the generation of the false signal and degradation in sharpness. Setting an optimum trade-off state corresponding to requirements for image shooting makes it possible to achieve a photograph with high image quality.

Note that the effects described in the present specification are illustrative and non-limiting, and may include other effects.

### 4. Other Embodiments

The technology by the present disclosure is not limited to description of the foregoing embodiment and may be modified in a variety of ways.

For example, the variable optical low-pass filter 30 is not limited to the configuration examples illustrated in FIGS. 3 to 6, and may have any other configuration. For example, the variable optical low-pass filter 30 may have a configuration in which a low-pass filter effect is achieved by minutely vibrating the imaging element 6 with use of a piezoelectric element. Moreover, for example, the variable optical low-ass filter 30 may have a configuration in which the liquid crystal layer 33, the first electrode 34, and the second electrode 35 are interposed between a first transparent substrate 36 and a second transparent substrate 37, and the first birefringent plate 31 and the second birefringent plate 32 are disposed outside thereof. In order not to exert an influence of birefringence, an optical isotropic material such as quartz glass may be preferably used for the first transparent substrate 36 and the second transparent substrate 37.

Moreover, the present technology may have the following configurations, for example.

(1) A filter control device, including a filter controller that performs control on a shot image to cause low-pass characteristics of an optical low-pass filter mounted in an imaging device to be changed in accordance with a magnification of the image, the magnification to be changed by image processing.

(2) The filter control device according to (1), further including a sharpness correction processor that corrects sharpness of the image by image processing, wherein the sharpness correction processor changes sharpness correction characteristics in accordance with the magnification.

(3) The filter control device according to (1) or (2), wherein the filter controller sets the low-pass characteristics of the optical low-pass filter to be weaker than when the magnification is one time in accordance with enlargement of the image by image processing and detection or prediction of occurrence of aliasing.

(4) The filter control device according to (3), wherein, when the image is enlarged by image processing and occurrence of aliasing is detected or predicted, the filter controller sets the low-pass characteristics of the optical low-pass filter to be stronger than when the occurrence of the aliasing is not detected or predicted.

(5) The filter control device according to (1) or (2), wherein, when the image is enlarged by image processing, the filter controller sets the low-pass characteristics of the optical low-pas filter to be weaker than before the image is enlarged.

(6) The filter control device according to any one of (1) to (5), wherein, when the image is reduced by image processing, the filter controller sets the low-pass characteristics of the optical low-pass filter to be stronger than before the image is reduced.

(7) The filter control device according to any one of (1) to (6), wherein, while focus adjustment by a focus adjustment operation section is performed, the filter controller sets a low-pass effect of the optical low-pass filter to be weaker than when the focus adjustment is not performed.

(8) The filter control device according to any one of (1) to (7), further including a Raw data recorder that records data indicating the low-pass characteristics of the optical low-pass filter together with Raw data.

(9) The filter control device according to any one of (1) to (8), wherein the imaging device displays the shot image as a live view image.

(10) The filter control device according to any one of (1) to (9), further including a low-pass filter effect setting section that is allowed to change the low-pass characteristics of the optical low-pass filter when a magnification of a live view image is changed.

(11) The filter control device according to any one of (1) to (10), wherein

the optical low-pass filter includes

a liquid crystal layer,

a first electrode and a second electrode that are disposed to face each other with the liquid crystal layer in between and apply an electric field to the liquid crystal layer, and

a first birefringent plate and a second birefringent plate that are disposed to face each other with the liquid crystal layer, the first electrode, and the second electrode in between, and

the low-pass characteristics are changed in accordance with change in voltage between the first electrode and the second electrode.

(12) A filter controlling method, comprising performing control on a shot image to cause low-pass characteristics of an optical low-pass filter mounted in an imaging device to be changed in accordance with a magnification of the image, the magnification to be changed by image processing.

(13) An imaging device, including:

an optical low-pass filter; and

a filter controller that performs control on a shot image to cause low-pass characteristics of the optical low-pass filter to be changed in accordance with magnification of the image before being changed by image processing.

This application claims the priority on the basis of Japanese Patent Application No. 2014-138060 filed on Jul. 3, 2014 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A filter control device, comprising a filter controller that performs control on a shot image to cause low-pass characteristics of an optical low-pass filter mounted in an imaging device to be changed in accordance with a magnification of the image, the magnification to be changed by image processing.

2. The filter control device according to claim 1, further comprising a sharpness correction processor that corrects sharpness of the image by image processing, wherein the sharpness correction processor changes sharpness correction characteristics in accordance with the magnification.

3. The filter control device according to claim 1, wherein the filter controller sets the low-pass characteristics of the optical low-pass filter to be weaker than when the magnification is one time in accordance with enlargement of the image by image processing and detection or prediction of occurrence of aliasing.

4. The filter control device according to claim 3, wherein, when the image is enlarged by image processing and occurrence of aliasing is detected or predicted, the filter controller sets the low-pass characteristics of the optical low-pass filter to be stronger than when the occurrence of the aliasing is not detected or predicted.

5. The filter control device according to claim 1, wherein, when the image is enlarged by image processing, the filter controller sets the low-pass characteristics of the optical low-pas filter to be weaker than before the image is enlarged.

6. The filter control device according to claim 1, wherein, when the image is reduced by image processing, the filter controller sets the low-pass characteristics of the optical low-pass filter to be stronger than before the image is reduced.

7. The filter control device according to claim 1, wherein, while focus adjustment by a focus adjustment operation section is performed, the filter controller sets a low-pass effect of the optical low-pass filter to be weaker than when the focus adjustment is not performed.

8. The filter control device according to claim 1, further comprising a Raw data recorder that records data indicating the low-pass characteristics of the optical low-pass filter together with Raw data.

9. The filter control device according to claim 1, wherein the imaging device displays the shot image as a live view image.

10. The filter control device according to claim 1, further comprising a low-pass filter effect setting section that is allowed to change the low-pass characteristics of the optical low-pass filter when a magnification of a live view image is changed.

11. The filter control device according to claim 1, wherein
the optical low-pass filter includes
a liquid crystal layer,
a first electrode and a second electrode that are disposed to face each other with the liquid crystal layer in between and apply an electric field to the liquid crystal layer, and
a first birefringent plate and a second birefringent plate that are disposed to face each other with the liquid crystal layer, the first electrode, and the second electrode in between, and
the low-pass characteristics are changed in accordance with change in voltage between the first electrode and the second electrode.

12. A filter controlling method, comprising performing control on a shot image to cause low-pass characteristics of an optical low-pass filter mounted in an imaging device to be changed in accordance with a magnification of the image, the magnification to be changed by image processing.

13. An imaging device, comprising:
an optical low-pass filter; and
a filter controller that performs control on a shot image to cause low-pass characteristics of the optical low-pass filter to be changed in accordance with a magnification of the image, the magnification to be changed by image processing.
